(19) United States
(12) Patent Application Publication
(10) Pub. No.: US 2008/0303209 A1
(43) Pub. Date: Dec. 11, 2008

(54) Gaming Console Storage Apparatus

(76) Inventor: John J. Engel, JR., Cincinnati, OH (US)

Correspondence Address: HASSE & NESBITT LLC, 8837 CHAPEL SQUARE DRIVE, SUITE C, CINCINNATI, OH, 45249, US

(21) Appl. No.: 11/760,904

(22) Filed: Jun. 11, 2007

(51) Int. Cl. A63F 13/08

(52) U.S. Cl. 273/148 B; 312/223.1

(57) ABSTRACT

A portable, light-weight storage apparatus for storing a video game console that also allows a user to sit comfortably in a couch or chair and play video games in front of a living room television or the like. The apparatus provides an “all-in-one” control center with multiple accessories, including an “arcade style” player pad, storage for the video game console unit, storage for a hand-held controller and video game media, instruction and code booklet storage, a player privacy shield and a drink holder. When not in use the storage unit can be easily transported away from the television area to an out of the way location.

### FIELD OF THE INVENTION

The present invention relates in general to storage systems for home video games, and more particularly to an apparatus for storing a home video game console.

### BACKGROUND OF THE INVENTION

Home video game consoles, such as Sony PlayStation™, Nintendo Wii™, and Microsoft X-box™, typically are made up of a console unit similar to a computer hard drive which can communicate audio and video signals to a television set or video screen, and one or more controllers for controlling the action of a game. Video game controllers can take a variety of forms, mainly dependent on the type of game to be controlled. These forms include, amongst others, a simple hand-held keypad controller which controls various game functions, a steering wheel controller (typically with a separate foot brake controller), a directional movement control stick (commonly known as a “joystick”), and a gun controller for firing missiles.

These video game controllers typically are linked to the console unit by a flexible wire or by wireless technology, and the console unit is similarly linked to a television set or computer video screen. An assortment of other accessories, such as DVD's or CD-ROM's (which are typically provided in their own separate boxes), game instruction booklets, code booklets, cables, wires, etc., are typically also part of current home video game systems.

The problem with having so many individual items related to a home video game system is that storage in a single location is frequently difficult and, furthermore, storing tidily so that the appearance of a room is not spoiled takes time and perseverance and, even then, is often not satisfactory. After playing, the controllers and DVD's, along with the game instructions and wires, are typically left strewn about the room, or else placed in a makeshift storage area such as a box or cupboard. Other furniture, such as couches, chairs and coffee tables, not necessarily designed to house video games and controllers, is often monopolized and thus rendered less usable for their originally intended function.

The prior art includes various patents disclosing efforts to improve the art of video game storage. For example, U.S. Pat. No. 5,324,036 to Morrow discloses a video game console with an inclined table top and a set of adjustable legs. The console includes compartments beneath the table top for holding video game cartridges, a central processing unit, and recessed receptacles for holding a variety of controllers. The table top is able to be opened along hinges to allow access to the interior compartments for wiring adjustments and the like. A bank of switches on the front panel allows the user to select which controller to use. Excess wires are reeled in by a spring loaded recoil reel.

U.S. Pat. No. 4,394,055 to Smith discloses a cabinet for storing home video games and their components, and includes an upper section for holding video game console units and a lower section for holding different sizes of video cartridges in an organized manner. The lower section includes transverse upstanding partial partitions and ribs configured to form compartments for holding game cartridges, controllers and instruction booklets.

U.S. Pat. No. 6,068,257 to Orfield discloses a video game storage system for holding a video game console unit, control pad input devices, and game cartridges having a bottom panel with an open top and open back main compartment for holding a video game console unit therein, a cartridge compartment for holding the game cartridges, and a side compartment for holding the controllers.

While the above inventions may be useful for their intended purposes, a continuing need exists in the art for a home video game console storage unit for storing home video games and their controllers in an organized manner while also allowing a user to easily play with the video games and their controllers.

### SUMMARY OF THE INVENTION

The present invention relates to an apparatus which provides garners with a portable, light-weight storage device for their video game consoles that also allows them to sit comfortably in a couch or chair and play video games in front of a living room television or the like. The apparatus provides an “all-in-one” control center with multiple optional accessories, including an “arcade style” player pad, storage for the video game console unit, storage for a hand-held controller and video game media, instruction and code booklet storage, a player privacy screen and a drink holder. When not in use the storage unit can be easily moved or carried away from the television area to an out of the way location.

A first aspect of the invention provides an apparatus for storing a video game console, the device comprising: (a) a top portion comprising an arcade pad operable to connect to a video game console unit, the arcade pad including video game controllers; (b) a middle portion configured to store the video game console unit, a plurality of video game media, and booklets related to the video game media; and (c) a bottom portion including a pedestal configured to provide the apparatus with a lower center of gravity, the pedestal including a plurality of extensions operable to extend outward from the pedestal, wherein the apparatus is taller than it is wide or deep.

A second aspect of the invention provides an apparatus for storing and playing with a video game console, the apparatus comprising: (a) a top portion comprising an arcade pad operable to connect to a video game console unit, the arcade pad including video game controllers; (b) a middle portion which is taller than it is wide or deep, the middle portion comprising: (i) an upper storage compartment configured to store the video game console unit therein; (ii) a plurality of intermediate storage compartments configured to store a plurality of video game media therein; and (iii) a lower storage compartment configured to store booklets related to the video game media therein; and (c) a bottom portion including a pedestal configured to provide the apparatus with a lower center of gravity, the pedestal including a plurality of extensions operable to extend outward from the pedestal.

A third aspect of the invention provides an apparatus for storing and playing with a video game console, the device comprising: (a) a top portion comprising an arcade pad operable to connect to a video game console unit, the arcade pad including video game controllers; (b) a bottom portion including a pedestal configured to provide the apparatus with a lower center of gravity, the pedestal including a plurality of extensions operable to extend outward from the pedestal; and (c) a middle portion comprising: (i) a base configured to form a floor for the middle portion, the base being connected to the pedestal and having a width and a depth that is smaller than the width and depth of the pedestal; (ii) a rear panel connected to the base and having a first height, wherein the first height is greater than the width or depth of the base; (iii) a right side panel connected to the base and having the first height; (iv) a left side panel connected to the base and having the first height; (v) a partition wall located between the right and left side panels and being oriented parallel thereto, the partition wall being connected to the rear panel and having a second height, the second height being less than the first height; (vi) an upper platform extending between the right side panel and the left side panel and located above and perpendicular to the partition wall, the upper platform providing a floor for an upper storage compartment, the upper storage compartment configured to store the video game console unit therein; (vii) a lower platform extending between the right side panel and the left side panel and located beneath and perpendicular to the partition wall, the lower platform providing a ceiling for a lower storage compartment, the lower storage compartment configured to store booklets related to the video game media therein; and (viii) a plurality of shelves configured to provide intermediate storage compartments for storing the video game media therein, the shelves being perpendicular to the partition wall and extending between the right side panel and the partition wall and between the left side panel and the partition wall.

The nature and advantages of the present invention will be more fully appreciated from the following drawings, detailed description and claims.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a perspective view of one embodiment of a gaming console storage unit of the invention.

FIG. 2 is another perspective view of the unit of FIG. 1 illustrating the extensions of the pedestal in the extended position.

FIG. 3 is a perspective view of the unit of FIG. 1 as it appears in use with two gamers.

FIG. 4 is a plan view of the top portion of the gaming console storage unit according to the invention.

### DETAILED DESCRIPTION OF THE INVENTION

As used herein, the term “arcade pad” is defined as an arcade-style player pad or gamepad that houses controllers for video games. As a non-limiting example, a currently well-known player pad is the X-Arcade™ Tankstick. An arcade pad can have anywhere from a couple of buttons to a dozen or more, combined with at least one omni-directional joystick which controls the game elements' movement (such as the game hero) in up to three dimensions, with many buttons to perform quick actions.

The term “video game console” means a complete video game package including a video game console unit, video game media, and instruction and code booklets related to the video game media. As a non-limiting example, video game consoles such as Sony PlayStation™, Nintendo Wii™, GameCube™ and Microsoft X-box™ typically are sold as a complete video game console.

The term “video game console unit” means an electronic unit which is the “brains” of the video game console. The console unit is similar to a computer hard drive which can play compatible video game media and communicate audio and video signals to a television set or video screen. The console unit is also able to receive signals from video game controllers for playing a selected video game.

The term “video game controller” means an input device used to control a video game. A game controller can be a keyboard, mouse, gamepad, joystick, paddle, or any other device designed for gaming that can receive input. Special purpose devices, such as steering wheels for driving games and light guns for shooting games, may also exist for a platform. Video game controllers can be used to govern the movement or actions of elements in a video game. The type of element controlled depends upon the game, but a typical element controlled would be the game hero.

The term “video game media” means a device for storing large amounts of data, especially high-resolution audio-visual material, such as CD's, DVD's and the like which are compatible with the console unit for operation and playing of video games. Data is typically stored on the media as a series of microscopic indentations (“pits”, with the gaps between them referred to as “lands”). A laser is shone onto the reflective surface of the media to read the pattern of pits and lands.

The term “hand-held controller” means a hand-held gamepad or a lightweight, portable type of video game controller held with both hands, where the thumbs are used to provide input. Hand-held controllers generally feature a set of action buttons handled with the right thumb and a direction controller handled with the left. Most modern game controllers typically include shoulder buttons placed along the edges of the pad, and centrally placed buttons labeled start, select, and mode.

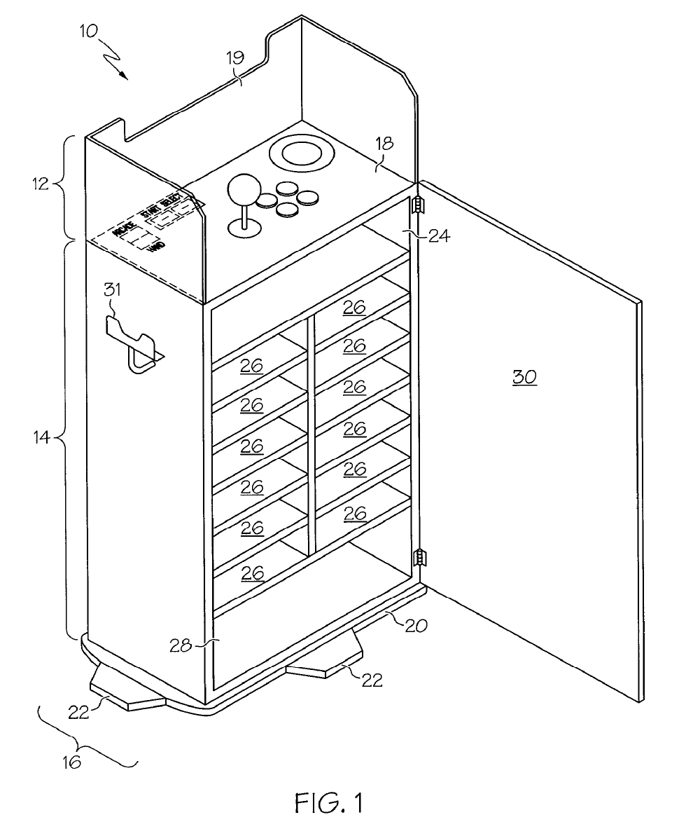

FIG. 1 illustrates one embodiment of an apparatus 10 of the invention for storing and playing with a video game console. In general, the apparatus 10 includes a top portion 12, an intermediate or middle portion 14, and a bottom portion 16. The top portion is illustrated having an arcade pad 18 designed to operate video game controller, and a detachable privacy screen 19. The bottom portion 16 includes a pedestal 20 configured to provide the apparatus 10 with a lower center of gravity. The pedestal includes a plurality of extensions 22 which are designed to extend outwardly from the pedestal 20 to provide a more stable foundation for the apparatus 10, which is typically taller than it is wide.

The middle portion 14, as illustrated in FIG. 1, is the portion of the apparatus 10 that gives the apparatus its height. That is, the middle portion 14 is taller than it is wide or deep in order to allow a user to sit in an ordinary chair or couch while playing a video game, as will be explained in more detail below. The space created by the middle portion 14 is used for storage, typically within storage compartments. That is, the middle portion 14 can include an upper storage compartment 24 sized for storing a video game console unit therein, a plurality of intermediate storage compartments 26 for storing a plurality of video game media therein, and a lower storage compartment 28 for storing instruction and code booklets therein. It is well-known in the gaming industry that such instruction and code booklets are often invaluable for the user in determining strategy and proper operation of a particular video game, such that having a storage compartment 28 for these booklets will help prevent them from being lost.

The middle portion 14 is typically enclosed by at least one door, such as door 30, to allow for easy transport of the apparatus 10 without causing the contents of the storage compartments 24, 26, 28 to fall out. The door 30 is typically hingably connected to the middle portion 14 and is lockable. The apparatus can also include a carrying strap (not shown) for carrying the apparatus from one location to another by a user when not in use, and a hook or clip 31 for attaching a hand-held controller to the apparatus 10 when not in use.

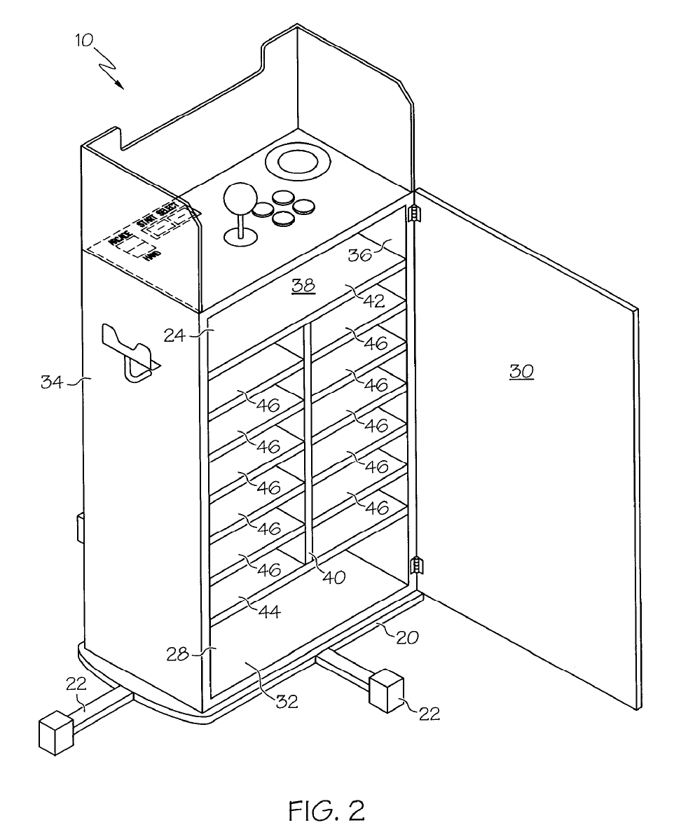

As illustrated in FIG. 2, the middle portion 14 is manufactured having a base 32 configured to form a floor for the middle portion. The base 32 sits atop and is connected to the pedestal 20, and, as illustrated, has a width and a depth that is smaller than the width and depth of the pedestal so that the pedestal 20 is able to create a wide foundation with a lower center of gravity for the apparatus. Extensions 22 of the pedestal 20 are illustrated in the extended position in FIG. 2. The extensions 22 are able to “telescope” out or otherwise create a wide foundation for the apparatus 10, so that the apparatus 10 has a lower center of gravity and thus is not prone to tip over during use. Further, the ends of the extensions 22 can include suction cups or discs (not shown) for added stability on slick surfaces such as a tile floor, a hardwood floor, or the like.

The middle portion 14 typically is manufactured having a right side panel 34, a left side panel 36, and a rear panel 38. The panels 34, 36, 38 are connected to the base 32 and typically have a first height that is greater than the width or depth of the base 32. A partition wall 40 is located between the right and left side panels 34, 36 and is oriented parallel thereto. The partition wall 40 is typically connected to the rear panel 38 and has a second height which less than the first height. Thus, the partition wall 40 is shorter than the height of the panels 34, 36, 38 so that the upper storage compartment 24 and the lower storage compartment 28 are able span from the right side panel 34 to the left side panel 36 without the partition wall 40 coming in between, thus allowing these compartments 24, 28 to be large enough to accommodate a video game console unit (in the upper compartment 24) and instruction and code booklets (in the lower compartment 28).

An upper platform 42 extends between the right side panel 34 and the left side panel 36, and is located in abutting relationship above, and perpendicular to, the partition wall 40, so that the upper platform 42 provides a floor for the upper storage compartment 24. A lower platform 44 extends between the right side panel 34 and the left side panel 36, and is located in abutting relationship beneath, and perpendicular to, the partition wall 40, so that the lower platform 44 provides a ceiling for a lower storage compartment 28. A plurality of shelves 46 are perpendicular to the partition wall and extend between the right side panel 34 and the partition wall 40, and also between the left side panel 36 and the partition wall 40. The shelves 46 create the intermediate storage compartments 26 for storing video game media therein, such as DVD's, CD's, gaming cartridges and the like.

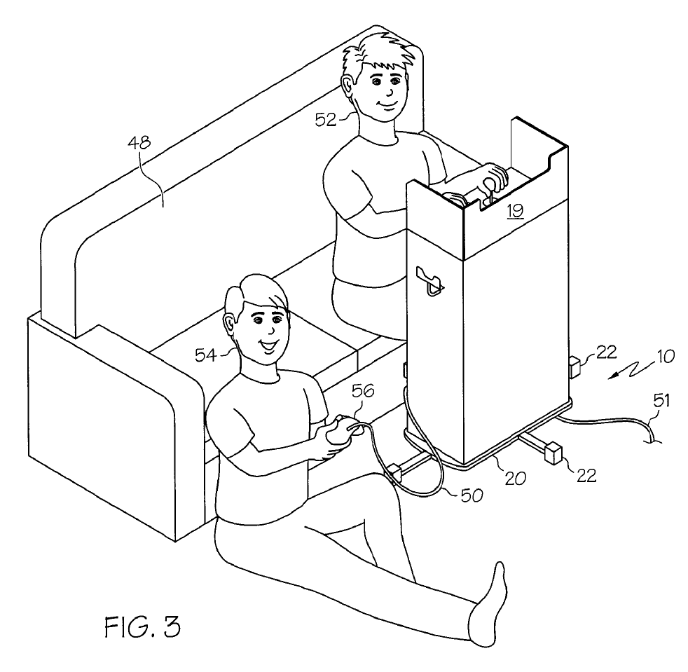

As illustrated in FIG. 3, the apparatus 10 of the invention is typically taller than it is wide or deep to allow a user to sit in a couch 48 while playing a video game. As shown, a first user 52 sits comfortably on a couch 48 behind the privacy screen 19 of the apparatus 10, which shields a second user 54 from viewing the actions of the first user 52. The second user 54 sits on the floor (or on the couch 48) and operates a hand-held controller 56, while the first user operates the arcade pad (18, FIG. 1) of the apparatus 10. If the video game being played so requires, wiring 50 connects the hand-held controller 56 to the video game console unit within the apparatus 10, and wiring 51 connects the video game console unit to a TV screen or monitor (not shown). The privacy screen 19 is useful in two-player games such as football or racing.

Typically the apparatus is between about 30 inches to about 40 inches in height, which allows the first user to sit on a typical couch or chair while playing with the arcade pad. The top and middle portions of the apparatus are typically between about 20 inches to about 24 inches wide, and between about 12 inches to about 16 inches deep, to accommodate the width and depth of an arcade pad (in the top portion) and a video game console unit (in the upper storage compartment of the middle portion). The pedestal is typically about 24 inches in width to create a wide foundation, and the extensions of the pedestal can extend outwardly to create a foundation of between about 48 inches to about 54 inches wide. The privacy shield is typically between about 6 inches to about 18 inches in height to block the view of others from the sides and or back of the apparatus. In an alternative embodiment (not shown) the top portion of the apparatus can be extended from about 3 inches to about 12 inches in height to accommodate a taller or shorter couch or chair. This embodiment would include extendable interior rails within the middle portion of the apparatus which are attached to the top portion. The rails could be extended upon the push of a button and lifting of the top portion to the desired height.

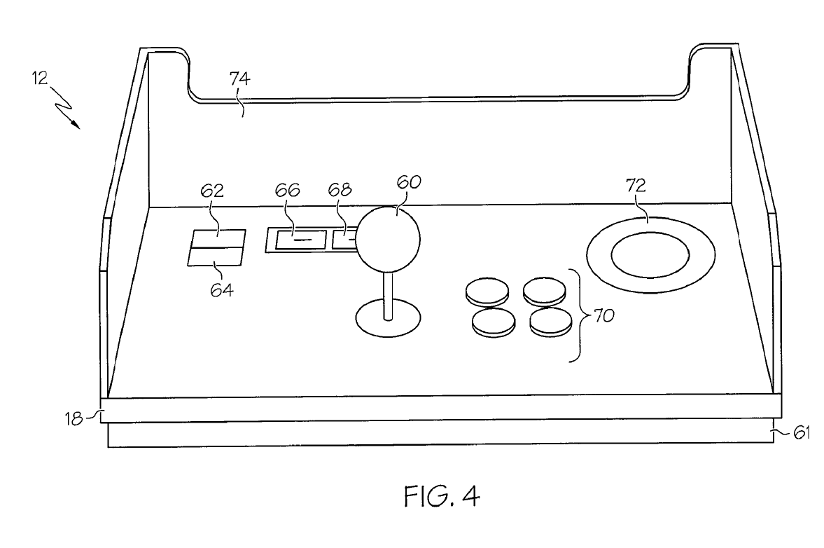

FIG. 4 illustrates a plan view of top portion 12 of the gaming console storage unit according to the invention. An arcade pad 18 is surrounded on three sides by a privacy screen 74, which is typically detachable therefrom. The privacy screen 74 can thus be removed if the playing conditions do not require its presence, thereby allowing the player more room for his arms and elbows to operate the controllers. The arcade pad 18 can be any of a variety of arcade pads which are well-known in the art, such as the X-Arcade Tankstick™. Nevertheless, the arcade pad 18 typically at least includes video game controllers such as a joystick 60, a plurality of game control buttons such as an arcade button 62 for switching the operation of the video game console unit to play the game through the arcade pad, a hand-controller button 64 for switching operation of the video game console unit to play the game through the hand-held controller, a select/mode button 66 for selecting various options within the video game being played such as the skill level of the game, a start button 68 for starting play of a selected video game, and a plurality of trigger buttons 70 for use in firing missiles or projectiles related to a selected video game.

A circuitry compartment 61 for holding the electrical components and wiring of the arcade pad 18 is located beneath the surface of the pad. The circuitry compartment 61 is designed to easily fit into the upper end of the middle portion of the apparatus. Further, the arcade pad 18 can include at least one drink holder 72 for holding cups or beverage glasses while the user is playing the video game. In one embodiment (not shown) a food tray can be built into the apparatus and located beneath the arcade pad, normally being entirely enclosed within the middle portion of the apparatus just below the arcade pad. The food tray is typically able to slide forward so that food, drinks and other materials can be placed thereon and enjoyed, as is known in the art, for example U.S. Pat. No. 4,040,659 to Arnold.

While the arcade pad 18 is illustrated with the joystick 60 and related buttons, the pad 18 can also include, or have the capacity to switch out the joystick 60 to include other game controllers, such as steering wheels for driving or motor-cross games, arcade balls for playing golf, finger grip controllers for aviation style games, and light guns for shooting games. Typically the hand-held controller (not shown) includes similar trigger buttons so that two players can play against one another as depicted in FIG. 3, and the arcade pad 60 is either wired to the hand-held controller and the video game console unit, or else the arcade pad 60, the hand-held controller and the video game console unit communicates via wireless technology, as is known in the art.

The apparatus of the invention is an improvement over the prior art because it is not bulky or overly large, such that it can be easily moved out of the way when not in use and then easily moved back into position when players are ready to play once again. It is tall and narrow and allows a single player to sit comfortably before it in a living room couch or chair while playing, and thus does away with the need for “gamer chairs” or the like which ultimately are unattractive additions to a family room. The apparatus can house approximately 40 video games in its storage compartments, in addition to housing the console unit, instruction and code booklets, arcade pad and hand-held controller, all in a single, lockable, transportable unit which a player can quickly and easily carry to another location.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope or spirit of the invention.

What is claimed is:

1. An apparatus for storing a video game console, the apparatus comprising:
a. a top portion comprising an arcade pad operable to connect to a video game console unit, the arcade pad including video game controllers;
b. a middle portion configured to store the video game console unit, a plurality of video game media, and booklets related to the video game media; and
c. a bottom portion including a pedestal configured to provide the apparatus with a lower center of gravity, the pedestal including a plurality of extensions operable to extend outward from the pedestal, wherein the apparatus is taller than it is wide or deep.

2. The apparatus of claim 1, wherein the video game controllers include a joystick, a hand-held controller, a plurality of game control buttons, and a plurality of trigger buttons.

3. The apparatus of claim 1, the top portion further comprising a privacy shield configured to block the view of others from seeing the arcade pad from the sides or the front of the apparatus.

4. The apparatus of claim 1, the top portion further comprising at least one drink holder for securing a drinking container.

5. The apparatus of claim 2, wherein the game control buttons include an arcade button operable to direct the video game console unit to operate the arcade pad, a hand-held unit button operable to direct the video game console unit to operate the hand-held controller, a select button operable to direct the video game console unit to select options for playing a selected video game, at least one player control button operable to direct the video game console unit to select which player will play the selected video game, and a start button operable to direct the video game console unit to start the selected game.

6. The apparatus of claim 2, wherein the trigger buttons are operable to direct the video game console unit to fire projectiles which are part of a selected video game.

7. The apparatus of claim 1, wherein the middle portion comprises:
i. an upper storage compartment configured to store the video game console unit therein;
ii. a lower storage compartment configured to store the booklets therein; and
iii. a plurality of intermediate storage compartments configured to store the plurality of video game media therein.

8. The apparatus of claim 1, wherein the middle portion comprises:
a. a base configured to form a floor for the middle portion, the base being connected to the pedestal and having a width and a depth that is smaller than the width and depth of the pedestal;
b. a rear panel connected to the base and having a first height, wherein the first height is greater than the width or depth of the base;
c. a right side panel connected to the base and having the first height;
d. a left side panel connected to the base and having the first height;
e. a partition wall located between the right and left side panels and being oriented parallel thereto, the partition wall being connected to the rear panel and having a second height, the second height being less than the first height;
f. an upper platform extending between the right side panel and the left side panel and located above and perpendicular to the partition wall, the platform providing a floor for an upper storage compartment, the upper storage compartment configured to store the video game console unit therein;
g. a lower platform extending between the right side panel and the left side panel and located beneath and perpendicular to the partition wall, the lower platform providing a ceiling for a lower storage compartment, the lower storage compartment configured to store the booklets therein;
h. a plurality of shelves configured to provide intermediate storage compartments for storing the plurality of video game media therein, the shelves being perpendicular to the partition wall and extending between the right side panel and the partition wall and between the left side panel and the partition wall; and
i. a lockable front door configured to enclose the storage compartments, the front door hingably connected to one of the right side panel and the left side panel.

9. The apparatus of claim 8, wherein the middle portion further comprises a carrying strap connected to at least one of the side panels for carrying the apparatus from one location to another by a user when not in use.

10. The apparatus of claim 8, wherein the middle portion further comprises a clip located on at least one of the side panels, the clip configured to provide a means for storing the hand-held controller when not in use.

11. An apparatus for storing and playing with a video game console, the apparatus comprising:
b. a top portion comprising an arcade pad operable to connect to a video game console unit, the arcade pad including video game controllers;
c. a middle portion which is taller than it is wide or deep, the middle portion comprising:
i. an upper storage compartment configured to store the video game console unit therein;
ii. a plurality of intermediate storage compartments configured to store a plurality of video game media therein; and
iii. a lower storage compartment configured to store booklets related to the video game media therein; and
d. a bottom portion including a pedestal configured to provide the apparatus with a lower center of gravity, the pedestal including a plurality of extensions operable to extend outward from the pedestal.

12. The apparatus of claim 11, further comprising a lockable front door hingably connected thereto and configured to enclose the storage compartments.

13. The apparatus of claim 11, further comprising a carrying strap for carrying the apparatus from one location to another by a user when not in use, and a clip configured to attach the hand-held controller to the apparatus when not in use.

14. The apparatus of claim 11, wherein the video game controllers include a joystick, a hand-held controller, a plurality of game control buttons, and a plurality of trigger buttons.

15. The apparatus of claim 11, the top portion further comprising a privacy shield configured to block the view of others from seeing the arcade pad from the sides or the front of the apparatus.

16. The apparatus of claim 11, the top portion further comprising at least one drink holder for securing a drinking container.

17. The apparatus of claim 14, wherein the game control buttons include an arcade button operable to direct the video game console unit to operate the arcade pad, a hand-held unit button operable to direct the video game console unit to operate the hand-held controller, a select button operable to direct the video game console unit to select options for playing a selected video game, at least one player control button operable to direct the video game console unit to select which player will play the selected video game, and a start button operable to direct the video game console unit to start the selected game.

18. The apparatus of claim 14, wherein the trigger buttons are operable to direct the video game console unit to fire projectiles which are part of a selected video game.

19. An apparatus for storing and playing with a video game console, the device comprising:
a. a top portion comprising an arcade pad operable to connect to a video game console unit, the arcade pad including video game controllers;
b. a bottom portion including a pedestal configured to provide the apparatus with a lower center of gravity, the pedestal including a plurality of extensions operable to extend outward from the pedestal; and
c. a middle portion comprising:
i. a base configured to form a floor for the middle portion, the base being connected to the pedestal and having a width and a depth that is smaller than the width and depth of the pedestal;
ii. a rear panel connected to the base and having a first height, wherein the first height is greater than the width or depth of the base;
iii. a right side panel connected to the base and having the first height;
iv. a left side panel connected to the base and having the first height;
v. a partition wall located between the right and left side panels and being oriented parallel thereto, the partition wall being connected to the rear panel and having a second height, the second height being less than the first height;
vi. an upper platform extending between the right side panel and the left side panel and located above and perpendicular to the partition wall, the upper platform providing a floor for an upper storage compartment, the upper storage compartment configured to store the video game console unit therein;
vii. a lower platform extending between the right side panel and the left side panel and located beneath and perpendicular to the partition wall, the lower platform providing a ceiling for a lower storage compartment, the lower storage compartment configured to store booklets related to the video game media therein; and
viii. a plurality of shelves configured to provide intermediate storage compartments for storing the video game media therein, the shelves being perpendicular to the partition wall and extending between the right side panel and the partition wall and between the left side panel and the partition wall.

20. The apparatus of claim 19, further comprising a lockable front door hingably connected thereto, a carrying strap, and a clip configured to removably attach the hand-held controller to the apparatus.
